(19) United States
(12) Patent Application Publication
(10) Pub. No.: US 2011/0127078 A1
(43) Pub. Date: Jun. 2, 2011

(54) MANUFACTURING METHOD OF PLATE-LIKE MEMBER ASSEMBLY AND TRANSPARENT SUBSTRATE-INCLUDING ELECTRONIC MEMBER

(75) Inventor: Satoshi KANEMITSU, Iruma-shi (JP)

(73) Assignee: Casio Computer Co., Ltd., Tokyo (JP)

(21) Appl. No.: 12/955,257

(22) Filed: Nov. 29, 2010

(30) Foreign Application Priority Data
Nov. 30, 2009 (JP) 2009-272054

(51) Int. Cl. H05K 1/16; B32B 37/02; B32B 38/14; B29C 65/00

(52) U.S. Cl. 174/260; 156/60; 156/277; 156/285

(57) ABSTRACT

A manufacturing method of a plate-like member assembly includes the steps of: preparing a first plate-like member including a projecting region, projecting from one surface of the first plate-like member along a thickness direction thereof, on the one surface; forming a light transmitting film, having a light transmitting property, in a nonoverlapping region, not-overlapping the projecting region, on the one surface of the first plate-like member; arranging a fixing member to cover a border between an overlapping region, overlapping the projecting region, and the nonoverlapping region with the light transmitting film intervening between the fixing member and the first plate-like member; and arranging a second plate-like member in such way that the light transmitting film and the fixing member intervene between the second plate-like member and the first plate-like member.

### CROSS-REFERENCE TO RELATED APPLICATIONS

This application is based upon and claims the benefit of priority under 35 USC 119 of Japanese Patent Application No. 2009-272054 filed on Nov. 30, 2009, the entire disclosure of which, including the description, claims, drawings, and abstract, is incorporated herein by reference in its entirety.

### BACKGROUND OF THE INVENTION

1. Field of the Invention

The present invention relates to a manufacturing method of a plate-like member assembly and a transparent substrate-including electronic member.

2. Description of the Related Art

For example, as described in Japanese Patent Application Laid-Open Publication No. 2008-90053, a transparent substrate-including electronic member, mounted in electronic equipment, such as portable equipment, has conventionally been known as a plate-like member assembly, including a plurality of laminated plate-like members. The transparent substrate-including electronic member is composed of, for example, a housing having an aperture portion; a protecting transparent substrate, arranged in the aperture portion to be stuck to the housing with an adhesive or a double-coated adhesive tape; and a display apparatus as an electronic member, arranged in the housing in such a way that the display surface thereof overlaps the transparent substrate (see, for example, Japanese Patent Application Laid-Open Publication No. 2008-90053). In the transparent substrate-including electronic member, the transparent substrate and the display apparatus are fixed to each other with a fixing member, such as a transparent adhesive, with the fixing member intervening between them.

A transparent substrate-including electronic member having an opposed surface of the transparent substrate, which surface is opposed to the display apparatus and is subjected to printing in a part thereof, has been known here. The region of the transparent substrate in which the printing is performed projects from the opposed surface to the thickness direction of the transparent substrate, though slightly, owing to the thickness of the printing. In the following, the printed region performed to the transparent substrate will be referred to as a projecting region. If the fixing member is arranged on the opposed surface of the transparent substrate from a position overlapping the projecting region to a position not-overlapping the projecting region, air containing parts where air intervenes between the fixing member and the transparent substrate are led to be formed. If the sizes of the air containing parts are large, the display contents of the display apparatus are obstructed to deteriorate the visual quality.

### BRIEF SUMMARY OF THE INVENTION

A manufacturing method of a plate-like member assembly of the present invention comprises the steps of:
preparing a first plate-like member including a projecting region, projecting from one surface of the first plate-like member along a thickness direction thereof, on the one surface;
forming a light transmitting film, having a light transmitting property, in a nonoverlapping region, not-overlapping the projecting region, on the one surface of the first plate-like member;
arranging a fixing member to cover a border between an overlapping region, overlapping the projecting region, and the nonoverlapping region with the light transmitting film intervening between the fixing member and the first plate-like member; and
arranging a second plate-like member in such a way that the light transmitting film and the fixing member intervene between the second plate-like member and the first plate-like member.

Furthermore, a manufacturing method of a plate-like member assembly of the present invention comprises the steps of:
preparing a first plate-like member including a projecting region, projecting from one surface of the first plate-like member along a thickness direction thereof, on the one surface;
arranging a fixing member to cover a border between an overlapping region, overlapping the projecting region, and a nonoverlapping region, not-overlapping the projecting region, on the one surface of the first plate-like member;
pressurizing the fixing member at a region overlapping the border in one surface opposite to the other surface which faces the first plate-like member toward the first plate-like member while heating the fixing member; and
arranging a second plate-like member in such a way that the fixing member intervenes between the second plate-like member and the first plate-like member.

Furthermore, a manufacturing method of a plate-like member assembly of the present invention comprises the steps of:
preparing a first plate-like member including a projecting region, projecting from one surface of the first plate-like member along a thickness direction thereof, on the one surface;
forming a light transmitting film, having a light transmitting property, in a nonoverlapping region, not-overlapping the first projecting region, on the one surface of the first plate-like member;
preparing a second plate-like member including a second projecting region, projecting from one surface of the second plate-like member along a thickness direction thereof, on the one surface;
arranging a fixing member to cover a border between an overlapping region, overlapping the second projecting region, and a nonoverlapping region, not-overlapping the second projecting region, on the one surface of the second plate-like member;
pressurizing the fixing member at a region overlapping the border in one surface opposite to the other surface which faces the second plate-like member toward the second plate-like member while heating the fixing member; and
arranging a first assembly including the first plate-like member and the light transmitting film and a second assembly of the second plate-like member and the fixing member in such a way that the light transmitting film and the fixing member overlap each other to fix the first assembly and the second assembly each other.

Furthermore, a manufacturing method of a plate-like member assembly of the present invention comprises the steps of:
preparing a first plate-like member including a first projecting region, projecting from one surface of the first plate-like member along a thickness direction thereof, on the one surface;
arranging a first fixing member to cover a first border between a first overlapping region, overlapping the first projecting region, and a first nonoverlapping region, not-overlapping the first projecting region, on the one surface of the first plate-like member;
pressurizing the first fixing member at a region overlapping the first border in one surface opposite to the other surface which faces the first plate-like member toward the first plate-like member while heating the first fixing member;
preparing a second plate-like member including a second projecting region, projecting from one surface of the second plate-like member along a thickness direction thereof, on the one surface;
arranging a second fixing member to cover a second border between a second overlapping region, overlapping the second projecting region, and a second nonoverlapping region, not-overlapping the second projecting region, on the one surface of the second plate-like member;
pressurizing the second fixing member at a region overlapping the second border in one surface opposite to the other surface which faces the second plate-like member toward the second plate-like member while heating the second fixing member; and
arranging a first assembly of the first plate-like member and the fixing member and a second assembly of the second plate-like member and the second fixing member in such a way that the fixing member and the second fixing member overlap each other to fix the first assembly and the second assembly each other.

Furthermore, a transparent substrate-including electronic member of the present invention comprises:
a transparent substrate including a printed region subjected to frame-shaped printing on one surface side thereof;
a light transmitting film, having a light transmitting property, the light transmitting film being formed to cover a whole region inside of the printed region and a whole of an inner edge of the printed region on the one surface of the transparent substrate;
a fixing member arranged to cover a border between a overlapping region, overlapping the printed region, and a nonoverlapping region, not-overlapping the printed region with the light transmitting film intervening between the fixing member and the transparent substrate; and
an electronic member which is one of a touch panel and a display panel, the electronic member being arranged in such a way that the light trans ting film and the fixing member intervene between the electronic member and the transparent substrate.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view schematically showing the schematic configuration of a transparent substrate-including electronic member according to a first embodiment;

FIG. 2 is a rear view showing the whole shape of a transparent substrate installed in the transparent substrate-including electronic member of FIG. 1;

FIG. 3 is a front view schematically showing the wiring structure of a touch panel installed in the transparent substrate-including electronic member of FIG.

FIG. 4 is a process chart showing the flow of a manufacturing method of the transparent substrate-including electronic member of FIG. 1;

FIG. 5 is an explanatory view schematically showing a process of the manufacturing method of FIG. 4;

FIG. 6 is an explanatory view schematically showing a process of the manufacturing method of FIG. 4;

FIG. 7 is an explanatory view schematically showing a process of the manufacturing method of FIG. 4;

FIG. 8 is an explanatory view schematically showing a process of the manufacturing method of FIG. 4;

FIG. 9 is a sectional view schematically showing the schematic configuration of a transparent substrate-including electronic member according to a second embodiment;

FIG. 10 is an explanatory view schematically showing a process of the manufacturing method of the transparent substrate-including electronic member of FIG. 9;

FIG. 11 is an explanatory view schematically showing a process of the manufacturing method of the transparent substrate-including electronic member of FIG. 9;

FIG. 12 is an explanatory view schematically showing a process of the manufacturing method of the transparent substrate-including electronic member of FIG. 9;

FIG. 13 is a front view schematically showing the wiring structure of a touch panel equipped in a transparent substrate-including electronic member of a third embodiment;

FIG. 14 is a sectional view schematically showing the schematic configuration of the transparent substrate-including electronic member of the third embodiment when the transparent substrate-including electronic member is looked at from a cutting plane line XIV-XIV in FIG. 13;

FIG. 15 is a sectional view schematically showing the schematic configuration of a transparent substrate-including electronic member according to a fourth embodiment;

FIG. 16 is a process chart showing the flow of the manufacturing method of a transparent substrate-including electronic member according to a fifth embodiment;

FIG. 17 is an explanatory view schematically showing a process of the manufacturing method of FIG. 16;

FIG. 18 is an explanatory view schematically showing a process of the manufacturing method of FIG. 16;

FIG. 19 is an explanatory view schematically showing a process of the manufacturing method of FIG. 16;

FIG. 20 is an explanatory view schematically showing a process of the manufacturing method of FIG. 16;

FIG. 21 is an explanatory view schematically showing a process of the manufacturing method of FIG. 16;

FIG. 22 is an explanatory view schematically showing a process of a manufacturing method of a transparent substrate-including electronic member according to a sixth embodiment;

FIG. 23 is an explanatory view schematically showing a process of the manufacturing method of the transparent substrate-including electronic member according to the sixth embodiment;

FIG. 24 is an explanatory view schematically showing a process of the manufacturing method of the transparent substrate-including electronic member according to the sixth embodiment;

FIG. 25 is a sectional view schematically showing the schematic configuration of a transparent substrate-including electronic member according to a seventh embodiment;

FIG. 26 is a sectional view schematically showing the schematic configuration of a transparent substrate-including electronic member according to an eighth embodiment;

FIG. 27 is a process chart showing the flow of a manufacturing method of the transparent substrate-including electronic member according to the eighth embodiment;

FIG. 28 is an explanatory view schematically showing a process of the manufacturing method of FIG. 27;

FIG. 29 is an explanatory view schematically showing a process of the manufacturing method of FIG. 27;

FIG. 30 is an explanatory view schematically showing a process of the manufacturing method of FIG. 27;

FIG. 31 is a sectional view schematically showing the schematic configuration of a transparent substrate-including electronic member according to a ninth embodiment;

FIG. 32 is a process chart showing the flow of a manufacturing method of the transparent substrate-including electronic member according to the ninth embodiment;

FIG. 33 is an explanatory view schematically showing a process of the manufacturing method of FIG. 32;

FIG. 34 is an explanatory view schematically showing a process of the manufacturing method of FIG. 32; and

FIG. 35 is an explanatory view schematically showing a process of the manufacturing method of FIG. 32.

### DETAILED DESCRIPTION OF THE INVENTION

Embodiments of the present invention will be explained with reference to the drawings.

In the following, the best mode for implementing the present invention will be described with reference to the accompanying drawings. Technically preferable various limitations for implementing the present invention are, however, added to the embodiments described below, but those limitations do not limit the scope of the invention to the following embodiments and shown examples.

### First Embodiment

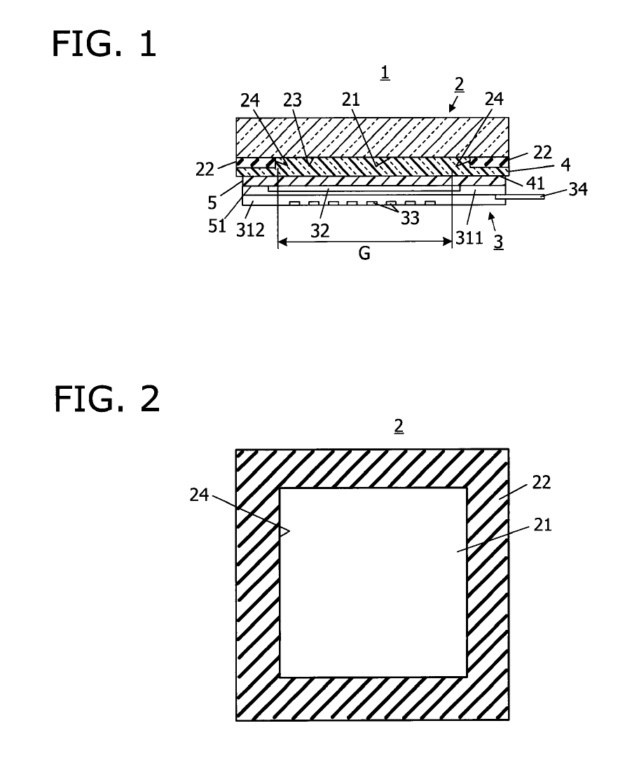

FIG. 1 is a sectional view schematically showing the schematic configuration of a transparent substrate-including electronic member according to a first embodiment. The transparent substrate-including electronic member 1 is, as shown in FIG. 1, equipped with a transparent substrate 2, which is a first plate-like member, a touch panel 3, which is a second plate-like member, a light transmitting film 4, and a fixing member 5.

The transparent substrate 2 protects a surface of the touch panel 3 opposed to the transparent substrate 2. FIG. 2 is a rear view showing the whole shape of the transparent substrate 2. As shown in FIG. 2, the transparent substrate 2 is formed in almost a rectangle by using tempered glass or a high strength transparent resin plate. On one surface (back surface 21) of the transparent substrate 2, a frame-shaped printed region 22 is formed over the whole circumference of the peripheral part of the transparent substrate 2. The printed region 22 is formed in a size that does not make the printing region 22 obstruct the operation region G of the touch panel 3. That is, the operation region G of the touch panel 3 falls into the region 23 on the inside of the printed region 22. Furthermore, the printed region 22, as shown in FIG. 1, slightly projects to the thickness direction of the transparent substrate 2 from the back surface 21. For example, if the printed region 22 is formed to be black, the thickness thereof is preferably made to be within a range of 10-15 μm. Furthermore, if the printed region 22 is formed to be white, the thickness thereof is preferably made to be within a range of 30-40 μm. The printed region 22 is a projecting region here.

The light transmitting film 4 is a resin film having a light transmitting property. To put it concretely, the light transmitting film 4 is formed by coating an acrylic ultraviolet ray (UV) curable resin (for example, LCR 1000 manufactured by Sony Chemical & Information Device Corporation) used as a hard coating agent. In addition, the light transmitting film 4 may be formed by coating a UV curable adhesive or printing a UV curable ink. As shown in FIG. 1, the light transmitting film 4 is formed to overlap the whole of the region 23 on the inside of the printed region 22 and the whole of the printed region 22 on the back surface 21 of the transparent substrate 2. In addition, the light transmitting film 4 need not overlap the whole of the printed region 22, and only the thing required for the light transmitting film 4 is to overlap at least the region overlapping the whole of the inner peripheral edge 24 of the printed region 22.

The fixing member 5 is made of a transparent adhesive sheet having a light transmitting property. The fixing member 5 is arranged with the light transmitting film 4 intervening between the fixing member 5 and the transparent substrate 2. The fixing member 5 is arranged continuously from a position overlapping the printed region 22 to a position not-overlapping the printed region 22 on a surface 41 of the light transmitting film 4 on a side thereof opposed to a side thereof on which the transparent substrate 2 is arranged to the light transmitting film 4. In other words, the fixing member 5 is arranged to cover a border, the inner peripheral edge 24, between a position overlapping the printed region 22 and the position not-overlapping the printed region 22 with the light transmitting film 4 intervening between the fixing member 5 and the transparent substrate 2.

The fixing member 5 is a solid having elasticity and stickiness under the conditions of a normal temperature and a normal pressure, and keeps the solid state having the elasticity and the stickiness also after the fixing member 5 has been fixed to the light transmitting film 4. As this sort of fixing member 5, transparent adhesive sheets, such as LUCIACS (registered trademark) CS9622T, manufactured by Nitto Denko Corp. and 3M Contrast Enhancement Film CEF0807, manufactured by Sumitomo 3M Ltd., can be used.

The touch panel 3 is a double-layer type capacitance-operated touch panel and detects the positional information of the tip of a finger or the like that touches the front surface of the touch panel 3 by a detection system, such as a relaxation oscillator system and a charge transfer system.

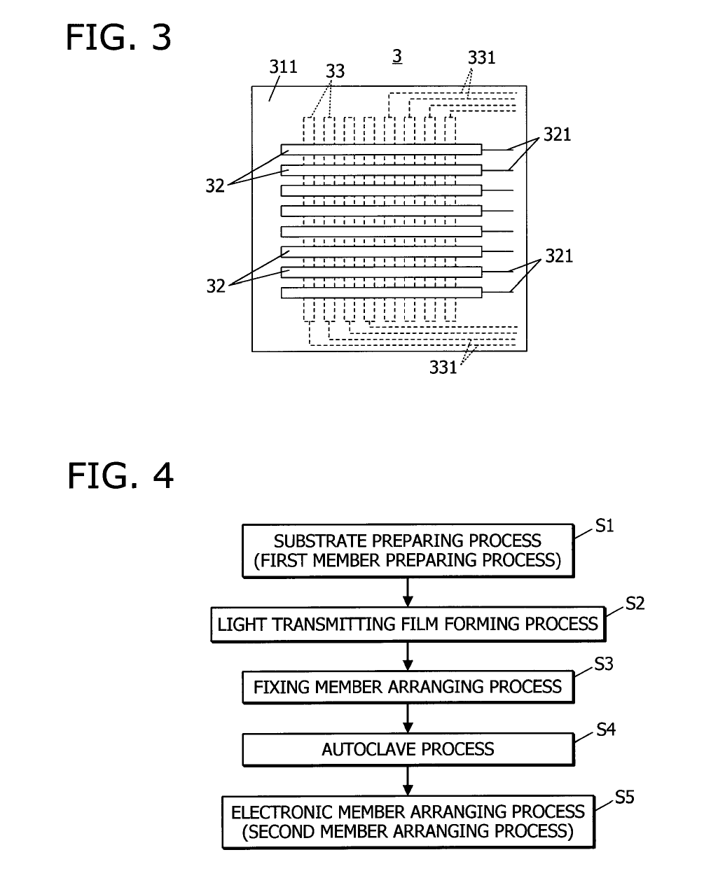

FIG. 3 is a front view schematically showing the wiring structure of the touch panel 3. As shown in FIGS. 1 and 3, the touch panel 3 is equipped with resin films 311 and 312, upper layer electrodes 32, lower layer electrodes 33, and a wiring film 34.

The resin films 311 and 312 are severally formed in almost a rectangle by use of a resin having a light transmitting property, such as a poly-ethylene terephthalate (PET) resin. The resin films 311 and 312 are superposed on each other in the state in which one resin film 311 is situated on the front surface side and the other resin film 312 is situated on the back surface side.

The upper layer electrodes 32 are transparent electrodes made of indium tin oxide (ITO), and a large number of them are arranged on the front surface side of the resin film 311. Furthermore, the large number of upper layer electrodes 32 is arranged at predetermined intervals from each other in order that the upper layer electrodes 32 may fall in the operation region G of the touch panel 3. Leading wiring 321 is connected to one end part of each of the large number of upper layer electrodes 32. The leading wiring 321 is made of ITO and is connected to the wiring in the wiring film 34.

The lower layer electrodes 33 is transparent electrodes made of ITO and a large number of them are arranged on the back surface side of the resin film 312. Furthermore, the large number of lower layer electrodes 33 extends in the directions perpendicular to the extending directions of the upper layer electrodes 32. Then, the large number of lower layer electrodes 33 is arranged at predetermined intervals from each other in order that the lower layer electrodes 33 may fall in the operation region G of the touch panel 3. Leading wiring 331 is connected to one end part of each of the large number of lower layer electrodes 33. The leading wiring 331 is made of ITO and is connected to the wiring in the wiring film 34.

Then, as shown in FIG. 1, the touch panel 3 is arranged with the light transmitting film 4 and the fixing member 5 intervening between the touch panel 3 and the transparent substrate 2. The touch panel 3 is superposed and fixed over the whole surface 51 of the fixing member 5 on the side opposed to the side on which the transparent substrate 2 is arranged to the fixing member 5. The touch panel 3 is, hereby, fixed by being arranged from a position overlapping the printed region 22 to a position not-overlapping the printed region 22 on the surface 51 on the opposite side.

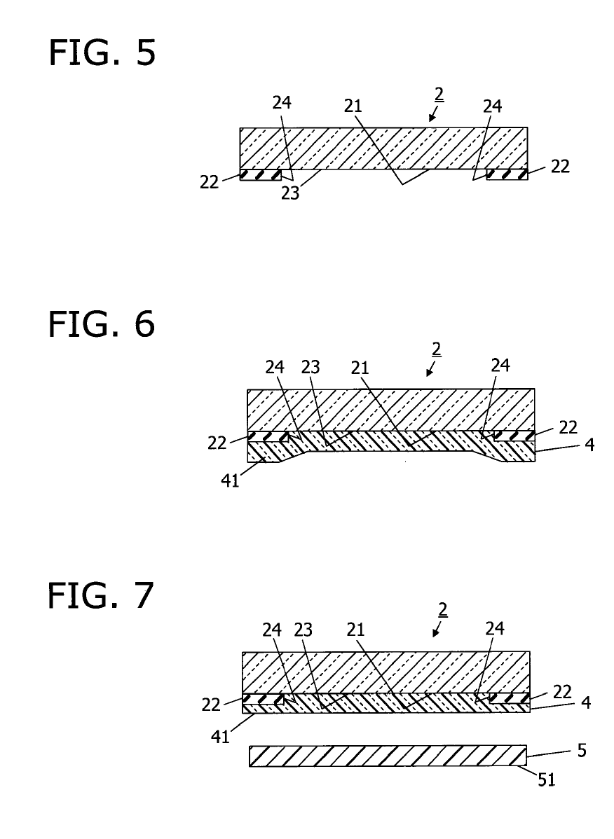

Next, a manufacturing method of the transparent substrate-including electronic member 1 of the present embodiment will be described. FIG. 4 is a process chart showing the flow of a manufacturing method of the transparent substrate-including electronic member 1. Furthermore, FIGS. 5-8 are explanatory views schematically showing the respective processes.

First, in a substrate preparing process S1, which is a first member preparing process, the transparent substrate 2 is prepared. The frame-shaped printed region 22 is formed on one surface side of the transparent substrate 2, which is the back surface 21 thereof, here (see FIG. 5).

Next, in a light transmitting film forming process S2, the light transmitting film 4 is formed by coating a hard coating agent continuously from a region not-overlapping the printed region 22 to a region overlapping the printed region 22 on the back surface 21 of the transparent substrate 2 (see FIG. 6). After the formation of the light transmitting film 4, predetermined processing is performed to the light transmitting film 4 at least in the region overlapping the printed region 22 in order that the region overlapping the printed region 22 may be thinner than the region not-overlapping the printed region 22 to flatten the surface 41 of the light transmitting film 4 on the opposite side (see FIG. 7) As the processing of thinning a part of the light transmitting film 4, for example, pressuring processing and removing processing can be given.

In the pressuring processing, at least a region consecutive from a position overlapping the printed region 22 to a position not-overlapping the printed region 22 of the surface 41 of the light transmitting film 4 on the opposite side thereof is pressurized toward the transparent substrate 2 after the formation of the light transmitting film 4. In other words, in the pressuring processing, the light transmitting film 4 is pressurized at a region overlapping the border in one surface 41 toward the transparent substrate 2 after forming the light transmitting film 4. And thereby the surface 41 of the light transmitting film 4 on the opposite side is flattened.

In the removing processing, at least a part of the light transmitting film 4 formed in the region overlapping the printed region 22 is removed in order that the thickness of the light transmitting film 4 in the region may be thin after the formation of the light transmitting film 4, and thereby the surface 41 of the light transmitting film 4 on the opposite side is flattened.

Furthermore, after the formation of the light transmitting film 4, leveling for making the slope of the surface 41 of the light transmitting film 4 on the opposite side thereof gentle is performed by heating the transparent substrate 2.

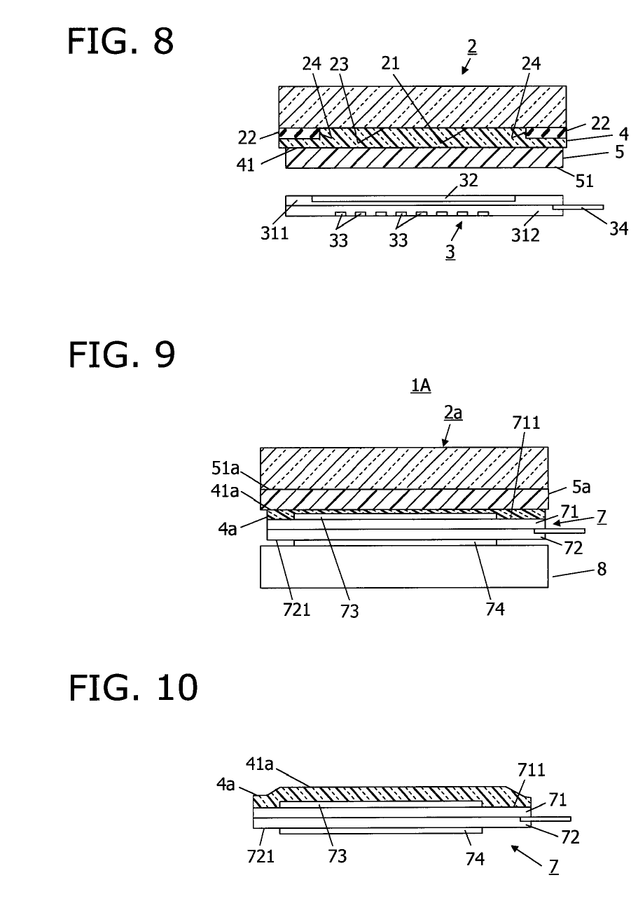

In a fixing member arranging process S3, the fixing member 5 is arranged continuously from a position overlapping the printed region 22 to a position not-overlapping the printed region 22 on the surface of the light transmitting film 4 on the opposite side thereof with the light transmitting film 4 intervening between the fixing member 5 and the transparent substrate 2 (see FIGS. 7 and 8). In the fixing member arranging process S3, the fixing member 5 is arranged on the surface 41 of the light transmitting film 4 on the opposite side thereof in the air.

In an autoclave process S4, an assembly of the transparent substrate 2, the light transmitting film 4, and the fixing member 5 is autoclaved. The autoclave process is the processing of giving a heat and a pressure to an assembly for a certain time.

In an electronic member arranging process S5, which is a second member arranging process, the touch panel 3 is pasted to the surface 51 of the fixing member 5 on the opposite side thereof (see FIG. 8). At this time, the touch panel 3 is fixed by being arranged from a position overlapping the printed region 22 to a position not-overlapping the printed region 22 on the surface 51 of the fixing member 5 on the opposite side thereof with the light transmitting film 4 and the fixing member 5 intervening between the touch panel 3 and the transparent substrate 2. The transparent substrate-including electronic member 1 is hereby completed (see FIG. 1). In addition, the fixing member 5 elastically deforms to contract owing to the pressurization by the pasting.

As described above, according to the manufacturing method of the transparent substrate-including electronic member 1 of the first embodiment, the transparent substrate-including electronic member 1 is manufactured, which transparent substrate-including electronic member 1 is equipped with: the transparent substrate 2 including the printed region 22 subjected to frame-shaped printing on one surface side thereof; the light transmitting film 4, having a light transmitting property, the light transmitting film 4 being formed in a region in the printed region 22 and a region overlapping the whole of the inner peripheral edge 24 of the printed region 22 on the one surface of the transparent substrate 2; the fixing member 5 arranged continuously from a position overlapping the printed region 22 to a position not-overlapping the printed region 22 with the light transmitting film 4 intervening between the fixing member 5 and the transparent substrate 2; and the electronic member 3, which is the touch panel, the electronic member 3 being arranged in such a way that the light transmitting film 4 and the fixing member 5 intervene between the electronic member 3 and the transparent substrate 2.

Furthermore, although the case where the electronic member 3 is the touch panel has been exemplified and described in the aforesaid manufacturing method of the transparent substrate-including electronic member 1 according to the first embodiment, it is needless to say that a display panel, which will be described in a second embodiment in detail, may be applied as the electronic member 3. In that case, the transparent substrate-including electronic member 1 is manufactured by the manufacturing method of the transparent substrate-including electronic member 1 according to the first embodiment, which transparent substrate-including electronic member 1 is equipped with: the transparent substrate 2 including the printed region 22 subjected to frame-shaped printing on one surface side thereof; the light transmitting film 4, having a light transmitting property, the light transmitting film 4 being formed in a region on the inside of the printed region 22 and a region overlapping the whole of the inner peripheral edge 24 of the printed region 22 on the one surface of the transparent substrate 2; the fixing member 5 arranged continuously from a position overlapping the printed region 22 to a position not-overlapping the printed region 22 with the light transmitting film 4 intervening between the fixing member 5 and the transparent substrate 2; and the electronic member 3, which is the display panel, the electronic member 3 being arranged in such a way that the light transmitting film 4 and the fixing member 5 intervene between the electronic member 3 and the transparent substrate 2.

Then, because the light transmitting film 4 is formed in a region of the back surface 21 of the transparent substrate 2, the region not-overlapping the printed region 22, according to the transparent substrate-including electronic member 1 of the first embodiment, the difference in level between the printed region 22 and the region 23 on the inside of the printed region 22 can be reduced. The generation of air containing parts between the fixing member 5 and the transparent substrate 2 can hereby be suppressed, and consequently the visual quality of the transparent substrate-including electronic member 1 can be enhanced.

Furthermore, because the light transmitting film 4 is formed continuously from the region not-overlapping the printed region 22 to the region overlapping the printed region 22 on the back surface 21 of the transparent substrate 2 in the light transmitting film forming process S2, the light transmitting film 4 is led to cover the printed region 22 and the region 23 on the inside of the printed region 22. For example, if the light transmitting film 4 is formed only in the region 23 on the inside of the printed region 22, the thickness of the light transmitting film 4 is preferably made to be the same thickness of the printed region 22. If the light transmitting film 4, however, covers the printed region 22 and the region 23 on the inside of the printed region 22 as described above, the difference in level between the printed region 22 and the light transmitting film 4 can be suppressed by forming the surface 41 of the light transmitting film 4 on the opposite side thereof to be flat by post-processing, such as pressuring processing and removing processing, even if the thickness of the light transmitting film 4 is not made to agree with the thickness of the printed region 22.

Furthermore, because leveling is performed by heating the transparent substrate 2 after forming the light transmitting film 4, the surface 41 of the light transmitting film 4 on the opposite side thereof can be made to be a gentler slope.

Furthermore, because the fixing member 5 is a solid having elasticity and stickiness under the conditions of a normal temperature and a normal pressure before the fixing member arranging process S3 and the fixing member 5 also keeps the solid state having the elasticity and the stickiness after the fixing member arranging process S3, it can also be considered that the fixing member 5 is elastically restored after the electronic member arranging process S5. Because the difference in level between the printed region 22 and the region 23 on the inside of the printed region 22 is, however, suppressed by the light transmitting film 4, it has become difficult to generate air containing parts even if the fixing member 5 is elastically restored.

Furthermore, because the fixing member 5 is arranged on the surface 41 of the light transmitting film 4 on the opposite side thereof in the air, the manufacturing process of the transparent substrate-including electronic member 1 can be simplified more than that of the case where the fixing member 5 is arranged in a vacuum.

Furthermore, because the light transmitting film 4 is made of a hard coating agent, the back surface 21 of the transparent substrate 2 can be covered by the hard coating.

Furthermore, because the assembly of the transparent substrate 2, the light transmitting film 4, and the fixing member 5 is autoclaved in the autoclave process S4, air bubbles are led to dissolve into the light transmitting film 4 and the fixing member 5, and the air containing parts can be reduced more.

In addition, although the autoclave process S4 is executed after the fixing member arranging process S3 and before the electronic member arranging process S5 in the aforesaid embodiment, the autoclave process may be executed only after the electronic member arranging process S5 or additionally. In this case, the assembly of the transparent substrate 2, the light transmitting film 4, the fixing member 5, and the touch panel 3 is autoclaved.

In addition, the present invention is not limited to the aforesaid embodiment but can suitably be changed. In the following, the other embodiments will be described. In the following description, the parts same as those of the aforesaid embodiment will be denoted by the marks same as those of the aforesaid embodiment and the description of the same parts will be omitted.

For example, although the touch panel 3 adopting a capacitance-operated one has been exemplified in the aforesaid embodiment, the touch panel 3 may adopt any one of resistive film type, optical type, electromagnetic induction type, and ultrasonic wave type ones.

Furthermore, although the light transmitting film 4 is formed continuously from the region not-overlapping the printed region 22 to the region overlapping the printed region 22 on the back surface 21 of the transparent substrate 2 in the light transmitting film forming process S2 of the aforesaid embodiment, the light transmitting film 4 may be formed only in the region 23 on the inside of the printed region 22 after making the thickness of the light transmitting film 4 to be the same thickness of the printed region 22. In this case, the processing of thinning a part of the light transmitting film 4, such as pressuring processing and removing processing, and the leveling processing of making the surface 41 of the light transmitting film 4 on the opposite side thereof to be a gentle slope may be omitted. Furthermore, although the surface 41 of the light transmitting film 4 on the opposite side thereof is flattened by performing predetermined processing at least to the region of the light transmitting film 4 overlapping the printed region 22 in the light transmitting film forming process S2 in the aforesaid embodiment, the difference in level between the level of the region overlapping the printed region 22 and the level of the region not-overlapping the printed region 22 on the surface 41 of the light transmitting film 4 on the opposite side thereof may be reduced.

### Second Embodiment

Although the transparent substrate-including electronic member 1, equipped with the touch panel 3 as the electronic member, has been exemplified to be described in the first embodiment, a transparent substrate-including electronic member equipped with a display panel as the electronic member will be exemplified to be described in a second embodiment. FIG. 9 is a sectional view schematically showing the schematic configuration of a transparent substrate-including electronic member 1A equipped with a display panel as the electronic member. As shown in FIG. 9, the transparent substrate-including electronic member 1A is equipped with a display panel 7, which is a first plate-like member; a transparent substrate 2a, which is a second plate-like member; a light transmitting film 4a; a fixing member 5a; and a light source unit 8.

The display panel 7 is a liquid crystal display panel and is equipped with a pair of transparent substrates 71 and 72, an optical sheet 73, and a second optical sheet 74.

The pair of transparent substrates 71 and 72 is arranged to be opposed to each other with a predetermined gap between them. A liquid crystal layer (not shown) is enclosed in the gap between the transparent substrates 71 and 72. Furthermore, first and second transparent electrodes (not shown) for forming a plurality of pixels are provided on the inner surfaces, opposed to each other, of the pair of transparent substrates 71 and 72, respectively, which electrodes control the transmission of light by changing the oriented states of the liquid crystal molecules in the liquid crystal layer by the application of a voltage.

The optical sheet 73 is a polarizing plate stuck on a surface 711 of the transparent substrate 71 on the observation side, which surface 711 is situated on the observation side of the transparent substrate 71. The optical sheet 73 is a projecting region projecting from the surface 711 on the observation side of the transparent substrate 71 on the observation side to the thickness direction of the transparent substrate 71.

The second optical sheet 74 is a second polarizing plate stuck onto the back surface 721 of the transparent substrate 72 on the back surface side.

The display panel 7 is an active matrix liquid crystal device using thin film transistors (TFTs) as active elements. Although it is omitted in the drawing, a plurality of pixel electrodes arranged in a matrix in row and column directions is formed on the inner surface of one (for example, the transparent substrate 72 on the back surface side) of the pair of transparent substrates 71 and 72. Furthermore, a plurality of TFTs (switching elements), arranged correspondingly to the plurality of pixel electrodes to be severally connected to a corresponding pixel electrode, is provided on the inner surface of the one transparent substrate. A plurality of scanning lines each for supplying a gate signal to a plurality of TFTs on each row and a plurality of signal lines each for supplying a data signal to a plurality of TFTs on each column are provided on the inner surface of the one transparent substrate.

Then, a counter electrode opposed to the whole region in which the plurality of pixel electrodes is arranged is formed on the inner surface of the other transparent substrate (for example, the transparent substrate 71 on the observation side). Furthermore, color filters of three colors of red, green, and blue are formed correspondingly to each of the plurality of pixels in the regions where the plurality of pixel electrodes and the counter electrode are opposed to each other on the inner surface of the other transparent substrate.

The light transmitting film. 4a is formed in such a way that the light transmitting film 4a is superposed on the whole of the optical sheet 73 and the whole of the region not-overlapping the optical sheet 73 on the surface 711 on the observation side of the transparent substrate 71.

The fixing member 5a is arranged with the light transmitting film 4a intervening between the fixing member 5a and, the display panel 7. The fixing member 5a is arranged continuously from a position overlapping the optical sheet 73 to a position not-overlapping the optical sheet 73 on the surface 41a of the light transmitting film 4a on the side thereof opposed to the side thereof on which the display panel 7 is arranged to the light transmitting film 4a.

The transparent substrate 2a is arranged with the light transmitting film 4a and the fixing member 5a intervening between the transparent substrate 2a and the display panel 7. The transparent substrate 2a is fixed by being superposed over the whole of the surface 51a of the fixing member 5a on the side opposite to the side on which the display panel 7 is arranged to the fixing member Sa. The transparent substrate 2a is, hereby, fixed by being arranged from a position overlapping the optical sheet 73 to a position not-overlapping the optical sheet 73 on the surface 51a on the opposite side.

The light source unit 8 is a surface light source and is arranged on the side opposite to the observation side of the display panel 7.

Next, a manufacturing method of the transparent substrate-including electronic member 1A of the second embodiment will be described.

FIGS. 10-12 are explanatory views schematically showing the respective processes of the manufacturing method of the transparent substrate-including electronic member 1A. In addition, the flow of the respective processes conforms to the one shown in FIG. 4.

First, in the substrate preparing process Si, which is the first member preparing process, the display panel 7, which is a first plate-like member, is prepared.

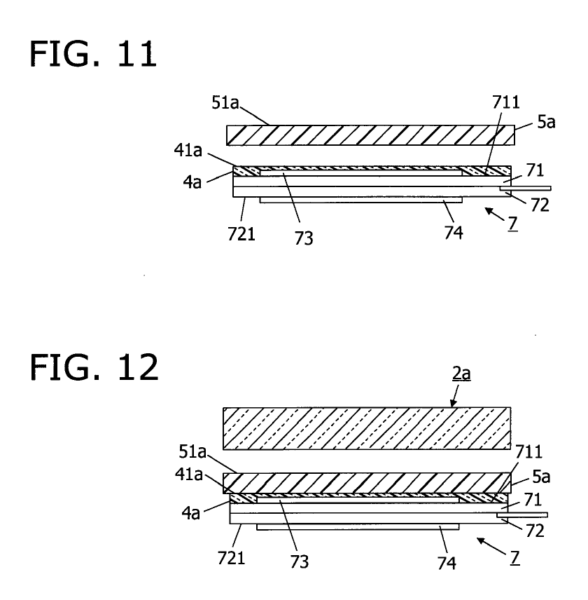

Next, in the light transmitting film forming process S2, the light transmitting film 4a is formed by coating a hard coating agent continuously from a region riot-overlapping the optical sheet 73 to a region overlapping the optical sheet 73 on one surface of the display panel (see FIG. 10). After the formation of the light transmitting film 4a, predetermined processing is performed to the region of the light transmitting film 4a, which region overlaps the optical sheet 73, in order that the region overlapping the optical sheet 73 may be thinner than the region not-overlapping the optical sheet 73, to reduce the difference in level between the region overlapping the optical sheet 73 and the region not-overlapping the optical sheet 73 on the surface 41a of the light transmitting film 4a on the opposite side thereof, or to flatten the surface 41a of the light transmitting film 4a on the opposite side thereof (see FIG. 11).

In the fixing member arranging process S3, the fixing member 5a is arranged continuously from a position overlapping the optical sheet 73 to a position not-overlapping the optical sheet 73 on the surface 41a of the light transmitting film 4a on the opposite side thereof with the light transmitting film 4a intervening between the fixing member 5a and the display panel 7 (see FIG. 12).

In the autoclave process S4, an assembly of the display panel 7, the light transmitting film 4a, and the fixing member 5a is autoclaved.

In the electronic member arranging process S5, which is the second member arranging process, the transparent substrate 2a is pasted to the surface 51a of the fixing member 5a on the opposite side thereof. At this time, the transparent substrate 2a is fixed by being arranged from a position overlapping the optical sheet 73 to a position not-overlapping the optical sheet 73 on the surface 51a of the fixing member 5a on the opposite side thereof with the light transmitting film 4a and the fixing member 5a intervening between the display panel 7 and the transparent substrate

After that, the light source unit 8 is arranged on the display panel 7 on the side thereof opposite to the observation side thereof, and thereby the transparent substrate-including electronic member 1A is completed (see FIG. 9).

As described above, because the light transmitting film 4a is formed in the region not-overlapping the projecting region (optical sheet 73), the difference in level between the projecting region and the region not-overlapping the projecting region can be reduced also if the difference in level is formed on the electronic member side. The generation of air containing parts between the fixing member 5a and the display panel 7 can hereby be suppressed, and consequently the visual quality of the transparent substrate-including electronic member 1A can be enhanced.

### Third Embodiment

Although the case where the projecting region is formed in the display panel 7 has been exemplified to be described in the second embodiment, the case where the projecting region is formed in a touch panel will be described in a third embodiment.

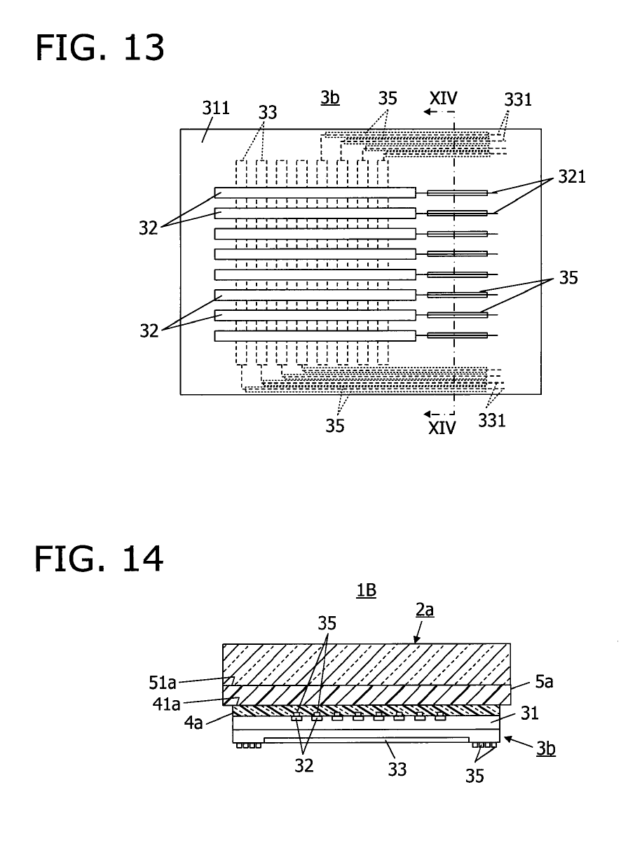

FIG. 13 is a front view schematically showing the wiring structure of a touch panel 3b installed in the transparent substrate-including electronic member 1B of a third embodiment. FIG. 14 is a sectional view schematically showing the schematic configuration of the transparent substrate-including electronic member 1E of the third embodiment taken along a cutting plane line XIV-XIV in FIG. 13. As shown in FIGS. 13 and 14, a plurality of metal layers 35 is formed as films on the front surface and the back surface of the touch panel 3b in such a way that the metal layers 35 cover at least parts of the leading wiring 321 and 331 individually. The metal layers 35 are formed by silver (Ag) paste printing, and the layer thickness is within a range of 10-20 μm. Consequently, the metal layers 35 arranged on the front surface side of the touch panel 3b are projecting regions.

In addition, the flow of the manufacturing processes of the transparent substrate-including electronic member 1B of the third embodiment conforms to those shown in FIG.

### Fourth Embodiment

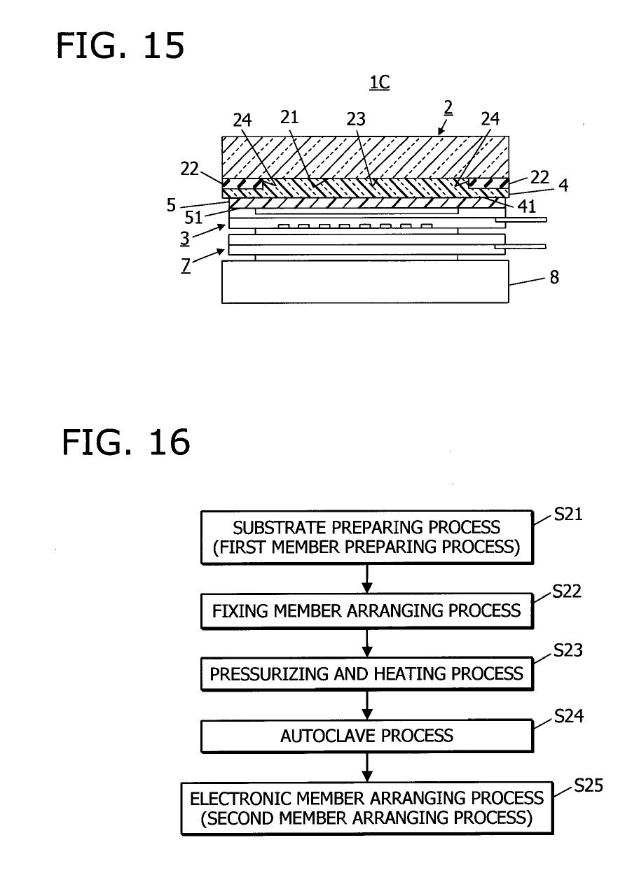

Although the case where the transparent substrate-including electronic member 1 mounts only the touch panel 3 as the electronic member thereon has been exemplified to be described in the first embodiment, a transparent substrate-including electronic member 1C, mounting both of the touch panel 3 and the display panel 7 thereon, will be described in a fourth embodiment. FIG. 15 is a sectional view schematically showing the schematic configuration of the transparent substrate-including electronic member 1C according to the fourth embodiment. As shown in FIG. 15, the transparent substrate-including electronic member 1C according to the fourth embodiment is equipped with the transparent substrate 2, the light transmitting film 4, the fixing member 5, the touch panel 3, the display panel 7, and the light source unit 8. The display panel 7 is arranged with the light transmitting film 4, the fixing member 5, and the touch panel 3 intervening between the display panel 7 and the transparent substrate 2.

In addition, the flow of the manufacturing processes of the transparent substrate-including electronic member 1C of the fourth embodiment conforms to that shown in FIG. 4. Furthermore, in the present embodiment, similarly to the first embodiment, the frame-shaped printed region 22 formed on one surface of the transparent substrate 2 (back surface 21) over the whole circumference of the peripheral part of the surface is the projecting region.

### Fifth Embodiment

Although the transparent substrate-including electronic member 1 equipped with the light transmitting film 4 for suppressing the generation of air containing parts has been exemplified to be described in the first embodiment, the generation of the air containing parts can be suppressed even if the light transmitting film 4 is omitted. A manufacturing method of a transparent substrate-including electronic member in the case of not using any light transmitting film 4 will be described in a fifth embodiment.

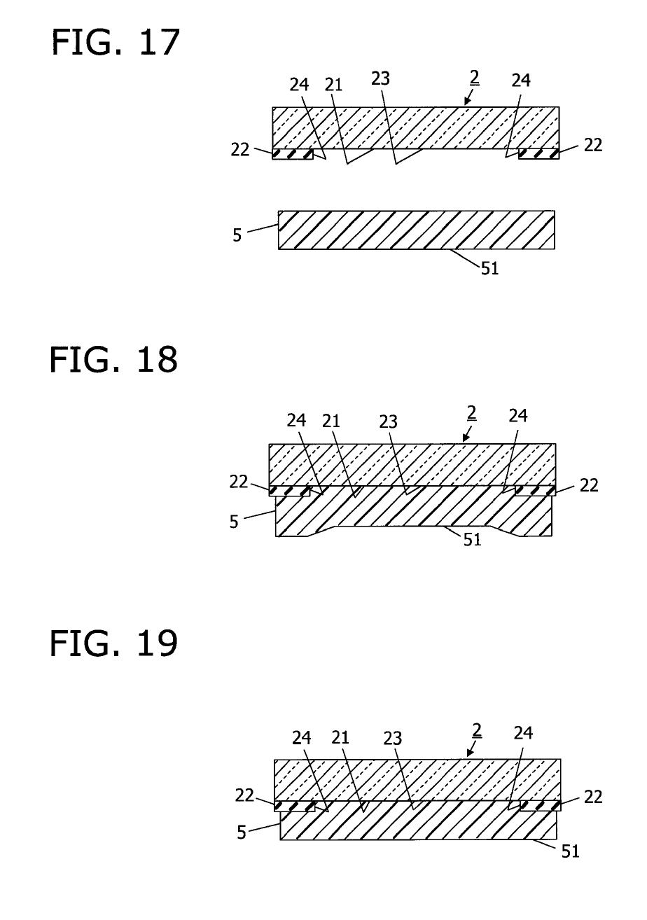

FIG. 16 is a process chart showing the flow of a manufacturing method of a transparent substrate-including electronic member according to the fifth embodiment. Furthermore, FIGS. 17-21 are explanatory views schematically showing respective processes.

First, in a substrate preparing process S21, which is a first member preparing process, the transparent substrate 2 is prepared. The frame-shaped printed region 22 is formed on one surface side of the transparent substrate 2, which is the back surface 21 thereof, here (see FIG. 17).

Next, in a fixing member arranging process S22, the fixing member 5 is arranged from a region not-overlapping the printed region 22 to a region overlapping the printed region 22 on the back surface 21 of the transparent substrate 2. In the fixing member arranging process S22, the fixing member 5 is arranged on the back surface 21 of the transparent substrate 2 in a vacuum. After the arrangement of the fixing member 5, the region overlapping the printed region 22 projects to the thickness direction of the transparent substrate 2 as shown in FIG. 18.

It is preferable to perform vacuuming up to, for example, about 30 Pa (2.961×10⁻⁴ atm) or less as the vacuum here. It is not, however, necessary to perform vacuuming up to 30 Pa or less as long as the generation of air containing parts can be suppressed.

In a pressurizing and heating process S23, the fixing member 5 is heated while a region consecutive at least from a position overlapping the printed region 22 to a position not-overlapping the printed region 22 on the surface 51 of the fixing member 5 on the opposite side thereof is pressurized toward the transparent substrate 2. The fixing member 5 hereby plastically deforms, and the surface 51 of the fixing member 5 on the opposite side thereof becomes flat (see FIG. 19).

In an autoclave process S24, an assembly of the transparent substrate 2 and the fixing member 5 is autoclaved.

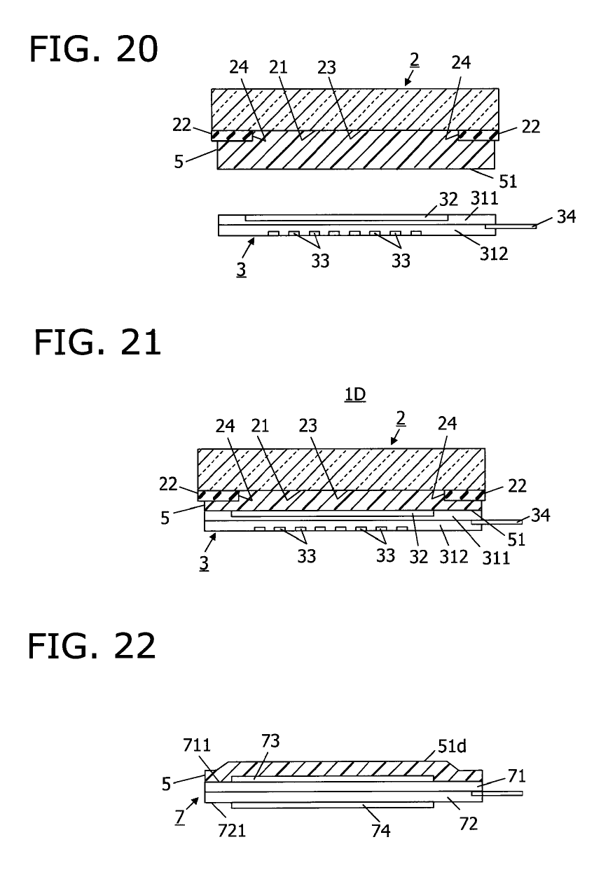

In an electronic member arranging process S25, which is a second member arranging process, the touch panel 3 is pasted to the surface 51 of the fixing member 5 on the opposite side thereof (see FIG. 20). At this time, the touch panel 3 is fixed by being arranged from a position overlapping the printed region 22 to a position not-overlapping the printed region 22 on the surface 51 of the fixing member 5 on the opposite side with the fixing member 5 intervening between the touch panel 3 and the transparent substrate 2. The transparent substrate-including electronic member 1D is hereby completed (see FIG. 21).

As described above, according to the manufacturing method of the transparent substrate-including electronic member 1D of the fifth embodiment, the surface 51 of the fixing member 5 on the opposite side thereof is flattened by the pressurizing and heating process S23, and consequently the generation of air containing parts between the fixing member 5 and the transparent substrate 2 can be suppressed to enhance the visual quality of the transparent substrate-including electronic member 1D.

In particular, because the fixing member 5 is plastically deformed in the pressurizing and heating process S23, it can be prevented that the fixing member 5 is restored to the original shape thereof after the assembling of the transparent substrate-including electronic member 1D. Consequently, it can be suppressed for a long period that air containing parts are generated between the fixing member 5 and the transparent substrate 2.

Furthermore, because the fixing member 5 is arranged on the back surface 21 of the transparent substrate 2 in a vacuum in the fixing member arranging process S22, it can be prevented that air enters between the fixing member 5 and the transparent substrate 2.

Furthermore, because the assembly of the transparent substrate 2 and the fixing member 5 is autoclaved in the autoclave process S24, air bubbles are led to dissolve into the fixing member 5, and the air containing parts can be reduced more.

In addition, although the autoclave process S24 is executed after the fixing member arranging process S22 and before the electronic member arranging process S25 in the aforesaid embodiment, the autoclave process may be executed only after the electronic member arranging process S25 or additionally. In this case, the assembly of the transparent substrate 2, the fixing member 5, and the touch panel 3 is autoclaved.

### Sixth Embodiment

Although the manufacturing method of the transparent substrate-including electronic member 1D, including the touch panel 3 as the electronic member, has been exemplified to be described in the fifth embodiment, a manufacturing method of a transparent substrate-including electronic member including a display panel as the electronic member will be described in a sixth embodiment.

In addition, similarly to the second embodiment, the optical sheet 73, stuck on the surface 711 on the observation side of the transparent substrate 71 is the projecting region.

FIGS. 22-24 are explanatory views schematically showing the respective processes of a manufacturing method of a transparent substrate-including electronic member according to the sixth embodiment. In addition, the flow of the respective processes conforms to the one shown in FIG. 16.

First, in the substrate preparing process S21, which is the first member preparing process, the display panel 7, which is the first plate-like member, is prepared.

Next, in the fixing member arranging process S22, the fixing member 5 is arranged from a region not-overlapping the optical sheet 73 to a region overlapping the optical sheet 73 on one surface of the display panel 7. After the arrangement of the fixing member 5, the region overlapping the optical sheet 73 projects to the thickness direction of the transparent substrate 71 as shown in FIG. 22.

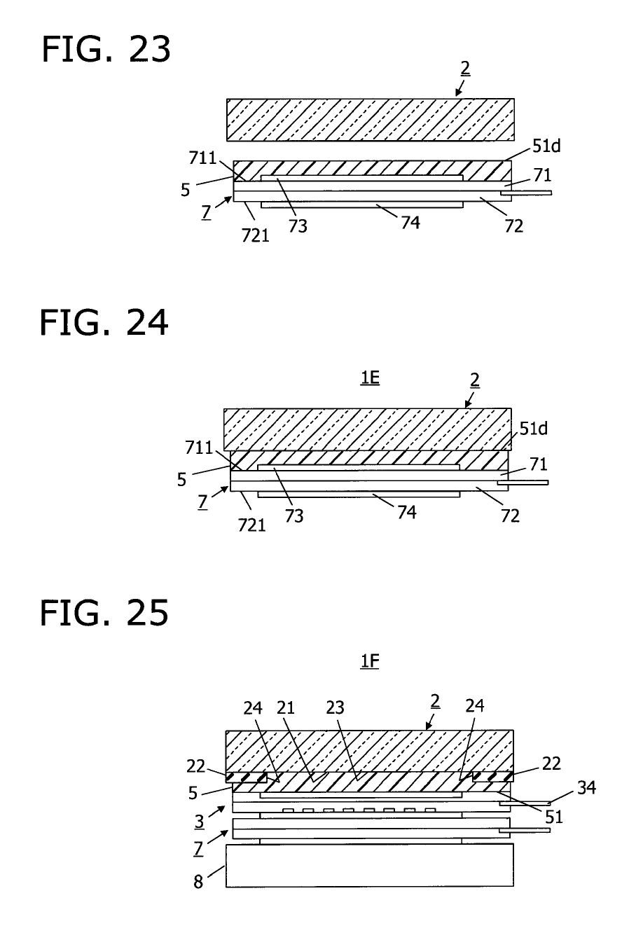

In the pressurizing and heating process S23, the fixing member 5 is heated while a region consecutive at least from a position overlapping the optical sheet 73 to a position not-overlapping the optical sheet 73 on the surface 51d of the fixing member 5 on the side opposite to the side on which the display panel 78 is arranged is pressurized toward the display panel 7. The fixing member 5 hereby plastically deforms, and the surface 51d of the fixing member 5 on the opposite side thereof becomes flat (see FIG. 23).

In the autoclave process S24, an assembly of the transparent substrate 2 and the fixing member 5 is autoclaved.

In the electronic member arranging process S25, which is the second member arranging process, the transparent substrate 2 is pasted to the surface 51d of the fixing member 5 on the opposite side thereof. At this time, the transparent substrate 2 is fixed by being arranged from a position overlapping the optical sheet 73 to a position not-overlapping the optical sheet 73 on the surface 51d of the fixing member 5 on the opposite side thereof with the fixing member 5 intervening between the transparent substrate 2 and the display panel 7.

After that, the light source unit 8 is arranged on the side opposite to the observation side of the display 7, and thereby the transparent substrate-including electronic member 1E is completed (see FIG. 24)

As described above, even if a difference in level exists on the electronic member side, the surface 51d of the fixing member 5 on the opposite side thereof is flattened by the pressurizing and heating process S23, and consequently the generation of air containing parts between the fixing member 5 and the transparent substrate 2 can be suppressed to enhance the visual quality of the transparent substrate-including electronic member 1E.

### Seventh Embodiment

Although the case where the transparent substrate-including electronic member 1D mounts only the touch panel 3 thereon as the electronic member has been exemplified and described in the fifth embodiment, a transparent substrate-including electronic member mounting both of the touch panel 3 and the display panel 7 thereon will be described in a seventh embodiment. FIG. 25 is a sectional view schematically showing the schematic configuration of a transparent substrate-including electronic member 1F according to the seventh embodiment. As shown in FIG. 25, the transparent substrates-including electronic member 1F according to the seventh embodiment is equipped with the transparent substrate 2, the fixing member 5, the touch panel 3, the display panel 7, and the light source unit 8. The display panel 7 is arranged with the fixing member 5 and the touch panel 3 intervening between the transparent substrate 2 and the display panel 7.

In addition, the flow of the manufacturing processes of the transparent substrate-including electronic member 1F conforms to that shown in FIG. 16. Furthermore, also in the present embodiment, similarly to the first embodiment, the frame-shaped printed region 22 formed on one surface of the transparent substrate 2 (back surface 21) over the whole circumference of the peripheral part thereof is the projecting region.

### Eighth Embodiment

Although the cases where the projecting regions are formed either of the transparent substrates and the electronic members have been exemplified and described in the aforesaid embodiments, the case where the projecting regions are formed both of the transparent substrate and the electronic member will be described in an eighth embodiment.

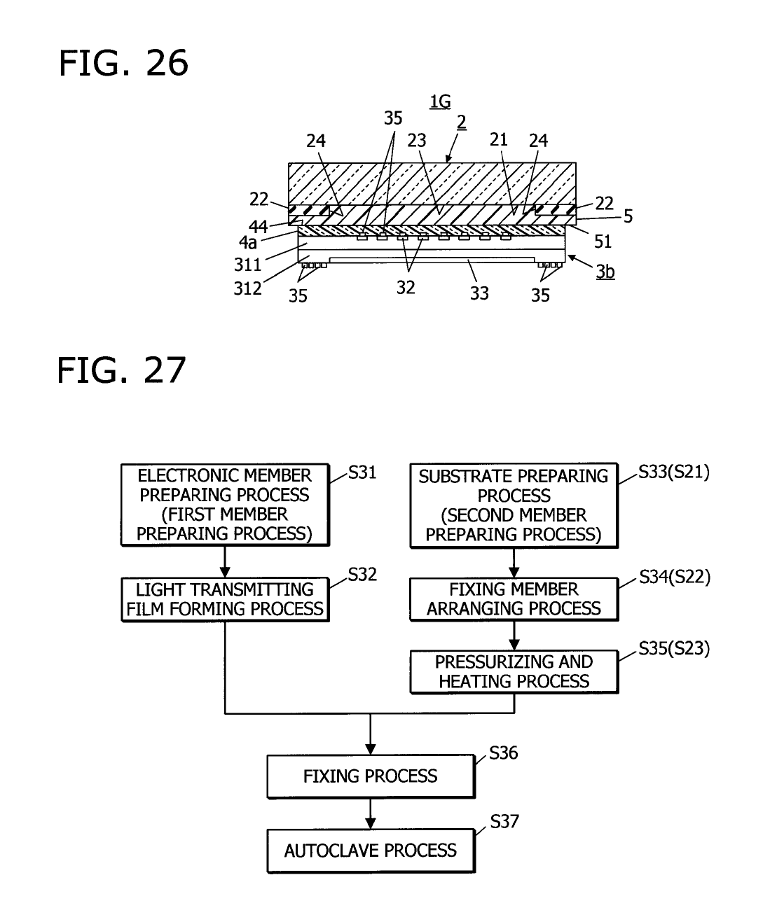

FIG. 26 is a sectional view schematically showing the schematic configuration of the transparent substrate-including electronic member 1G of the eighth embodiment. As shown in FIG. 26, the transparent substrate-including electronic member 1G is equipped with the transparent substrate 2, the fixing member 5, the light transmitting film 4a, and the touch panel 3b.

The transparent substrate 2 is the second plate-like member, the printed, region 22 formed on the back surface 21 of the transparent substrate 2 is the second projecting region.

The fixing member 5 is formed in such a way that the fixing member 5 overlaps the whole region 23 on the inside of the printed region 22 and the whole of the printed region 22 on the back surface 21 of the transparent substrate 2.

The touch panel 3b is the first plate-like member, and the metal layers 35 formed on the surface thereof are projecting regions.

The light transmitting film 4a is superposed on the front surface side of the touch panel 3b. To put it concretely, the light transmitting film 4a is arranged continuously from positions overlapping the metal layers 35 to positions not-overlapping the metal layers 35 on the front surface side of the touch panel 3b.

Then, the fixing member 5 and the light transmitting film 4a are superposed on each other in such a way that the operation region G of the touch panel 3b fall into the region 23 on the inside of the printed region 22.

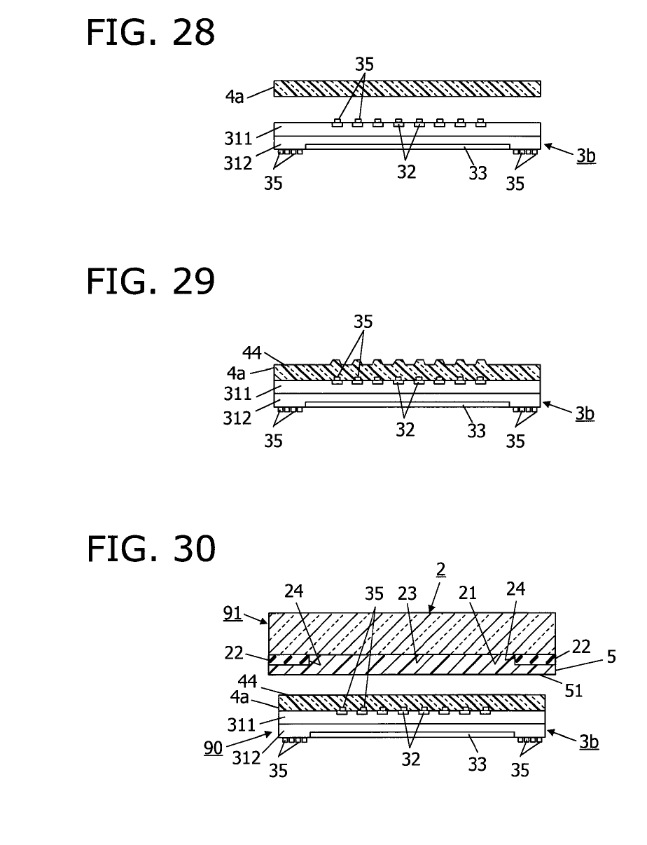

Next, a manufacturing method of the transparent substrate-including electronic member 1G of the present embodiment will be described. FIG. 27 is a process chart showing the flow of a manufacturing method of the transparent substrate-including electronic member 1G. FIGS. 28-30 are explanatory views schematically showing the respective processes. In addition, because a substrate preparing process S33, a fixing member arranging process S34, and a pressurizing and heating process S35 are the processes same as the substrate preparing process S21, the fixing member arranging process S22, and the pressurizing and heating process S23 of the fifth embodiment, respectively, their descriptions are omitted.

First, in an electronic member preparing process S31, which is the first member preparing process, the touch panel 3b is prepared. The metal layers 35, which are projecting regions, are formed on one surface side, which is the front surface side, of the touch panel 3b here (see FIG. 28).

Next, in a light transmitting film forming process S32, the light transmitting film 4a is formed by coating a hard coating agent continuously from regions not-overlapping the metal layers 35 on the front surface side of the touch panel 3b to regions overlapping the metal layers 35 on the front surface side (see FIG. 29). After the formation of the light transmitting film 4a, predetermined processing is performed to the regions of the light transmitting film 4a, which regions overlap the metal layers 35, in order that the regions overlapping the metal layers 35 may be thinner than the regions not-overlapping the metal layers 35 to flatten the surface 44 of the light transmitting film 4a (see FIG. 30).

In a fixing process S36, the assembly 90 of the touch panel 3b and the light transmitting film 4a and the assembly 91 of the transparent substrate 2 and fixing member 5 are fixed by being arranged in such a way that the front surface 44 of the light transmitting film 4a and the surface 51 of the fixing member 5 on the opposite side thereof overlap each other. At this time, the assembly 90 and the assembly 91 are aligned with each other in order that the operation region G of the touch panel 3b may fall into the region 23 on the inside of the printed region 22.

After that, in an autoclave process S37, the assembly of the transparent substrate 2, the fixing member 5, the light transmitting film 4a, and the touch panel 3b is autoclaved. The transparent substrate-including electronic member 1G is hereby completed (see FIG. 26).

As described above, according to the eighth embodiment, even if the projecting regions are formed on both the transparent substrate 2 and the touch panel 3b, the respective joint surfaces (the front surface 44 and the surface 51 on the opposite side) of the fixing member 5 and the light transmitting film 4a are flattened to be overlapped on each other, and consequently the generation of air containing parts between the touch panel 3b and the transparent substrate 2 can be suppressed to enhance the visual quality of the transparent substrate-including electronic member 1G.

### Ninth Embodiment

Although the transparent substrate-including electronic member 1G, equipped with the light transmitting film 4a for suppressing the generation of the air containing parts, has been exemplified to be described in the eighth embodiment, even if the light transmitting film 4a is omitted, the generation of the air containing parts can be suppressed. A manufacturing method of a transparent substrate-including electronic member not using the light transmitting film 4a will be described in a ninth embodiment.

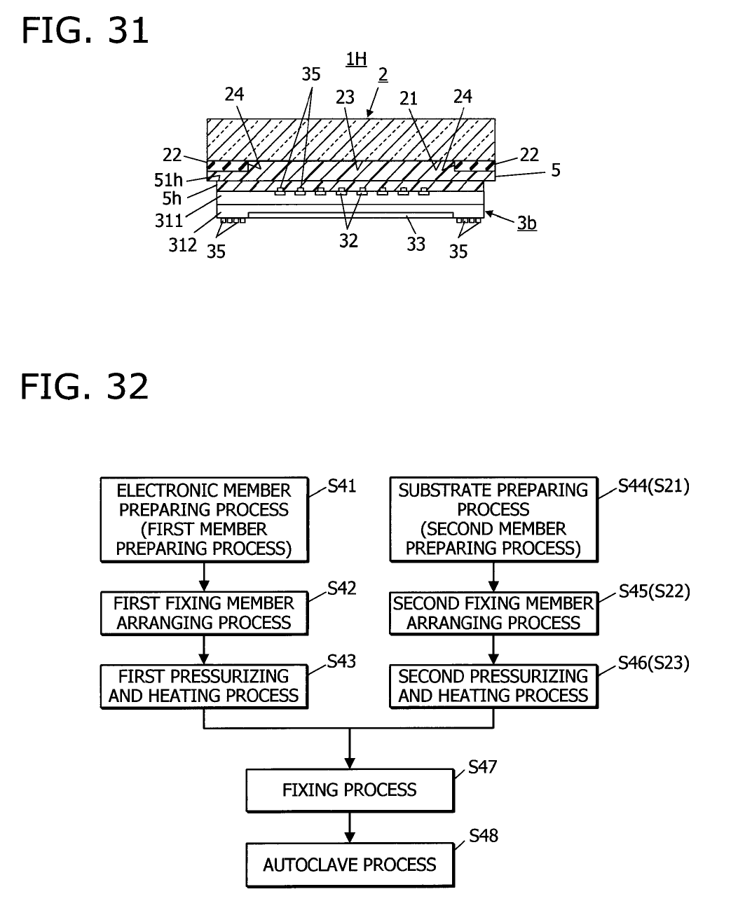

FIG. 31 is a sectional view schematically showing the schematic configuration of a transparent substrate-including electronic member 1H of a ninth embodiment. As shown in FIG. 31, the transparent substrate-including electronic member 1H is equipped with the transparent substrate 2, the fixing member 5, a fixing member 5h, and the touch panel 3b.

The transparent substrate 2 is the second plate-like member, and the printed region 22 formed on the back surface 21 of the transparent substrate 2 is the second projecting region.

The fixing member 5 is a second fixing member and is formed in such a way that the fixing member 5 overlaps the whole region 23 on the inside of the printed region 22 and the whole of the printed region. 22 on the back surface 21 of the transparent substrate 2.

The touch panel 3b is the first plate-like member, and the metal layers 35 formed on the surface thereof are projecting regions.

The fixing member 5h is overlapped on the front surface side of the touch panel 3b. To put it concretely, the fixing member 5h is arranged continuously from positions overlapping the metal layers 35 on the front surface side of the touch panel 3b to positions not-overlapping the metal layer 35 on the front surface side.

Then, the fixing members 5 and 5h are overlapped on each other in such a way that the operation region G of the touch panel 3b falls into the region 23 on the inside of the printing region 22.

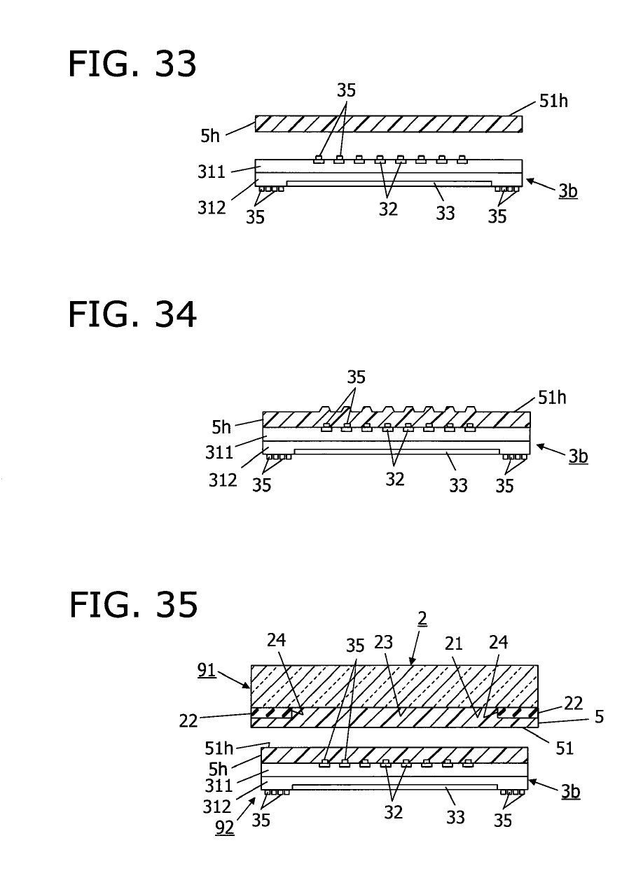

Next, a manufacturing method of the transparent substrate-including electronic member 1H of the present embodiment will be described. FIG. 32 is a process chart showing the flow of a manufacturing method of the transparent substrate-including electronic member 1H. FIGS. 33-35 are explanatory views schematically showing the respective processes. In addition, because a substrate preparing process S44, a second fixing member arranging process S45, and a second pressurizing and heating S46 are the processes same as the substrate preparing process S21, the fixing member arranging process S22, and the pressurizing and heating process S23 of the fifth embodiment, respectively, their descriptions are omitted.

First, in an electronic member preparing process S41, which is the first member preparing process, the touch panel 3b is prepared (see FIG. 33).

Next, in a fixing member arranging process S42, the fixing member 5h is arranged from regions not-overlapping the metal layers 35 to regions overlapping the metal layers 35 on the front surface side of the touch panel 3b. In the fixing member arranging process S42, the fixing member 5h is arranged on the touch panel 3b in a vacuum. After the arrangement of the fixing member 5h, the regions overlapping the metal layers 35 project to the thickness direction of the resin film 311 as shown in FIG. 34.

In a pressurizing and heating process S43, the fixing member 5h is heated while the regions consecutive at least from the positions overlapping the metal layers 35 to the positions not-overlapping the metal layers 35 on the surface 51h of the fixing member 5h on the side opposite to the side of the fixing member 5h on which side the touch panel 3b is arranged are pressurized toward the touch panel 3b. The fixing member 5h hereby plastically deforms, and the surface 51h of the fixing member 5h on the opposite side thereof becomes flat (see FIG. 35).

In a fixing process S47, the assembly 92 of the touch panel 3b and the fixing member 5h and the assembly 91 of the transparent substrate 2 and fixing member 5 are fixed by being arranged in such a way that the surface 51 of the fixing member 5 on the opposite side thereof and the surface 51h of the fixing member 5h on the opposite side thereof overlap each other. At this time, the assembly 92 and the assembly 91 are aligned with each other in order that the operation region G of the touch panel 3b may fall into the region 23 on the inside of the printed region 22.

After that, in an autoclave process S48, the assembly of the transparent substrate 2, the fixing member 5, the fixing member 5h, and the touch panel 3b is autoclaved. The transparent substrate-including electronic member 1H is hereby completed. (see FIG. 31).

As described above, according to the ninth embodiment, even if the projecting regions are formed on both the transparent substrate 2 and the touch panel 3b, the respective joint surfaces (the surfaces 51 and 51h on the opposite side) of the fixing members 5 and 5h are flattened to be overlapped on each other, and consequently the generation of air containing parts between the touch panel 3b and the transparent substrate 2 can be suppressed to enhance the visual quality of the transparent substrate-including electronic member 1H.

In addition, although the display panels 7 exemplified in the aforesaid embodiments are the liquid crystal display panels, a plasma display panel, an organic electroluminescent display panel, a field emission display panel, and the like can be given in addition to the liquid crystal display panel as the display panels 7.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A manufacturing method of a plate-like member assembly, comprising the steps of:
preparing a first plate-like member including a projecting region, projecting from one surface of the first plate-like member along a thickness direction thereof, on the one surface;
forming a light transmitting film, having a light transmitting property, in a nonoverlapping region, not-overlapping the projecting region, on the one surface of the first plate-like member;
arranging a fixing member to cover a border between an overlapping region, overlapping the projecting region, and the nonoverlapping region with the light transmitting film intervening between the fixing member and the first plate-like member; and
arranging a second plate-like member in such a way that the light transmitting film and the fixing member intervene between the second plate-like member and the first plate-like member.

2. The manufacturing method of a plate-like member assembly according to claim 1, wherein the step of forming the light transmitting film includes forming the light transmitting film to cover the border on the one surface of the first plate-like member.

3. The manufacturing method of a plate-like member assembly according to claim 2, wherein the step of forming the light transmitting film includes forming the light transmitting film in such a way that a thickness of the light transmitting film in the overlapping region is thinner than the thickness of the light transmitting film in the nonoverlapping region.

4. The manufacturing method of a plate-like member assembly according to claim 2, further comprising the step of pressurizing the light transmitting film at a region overlapping the border in one surface opposite to the other surface which faces the first plate-like member toward the first plate-like member after forming the light transmitting film.

5. The manufacturing method of a plate-like member assembly according to claim 2, further comprising the step of removing a part of the light transmitting film in the overlapping region to make a thickness of the light transmitting film thinner after forming the light transmitting film.

6. The manufacturing method of a plate-like member assembly according to claim 2, further comprising the step of heating the first plate-like member and the light transmitting film after forming the light transmitting film.

7. The manufacturing method of a plate-like member assembly according to claim 1, wherein the fixing member is a solid having elasticity and stickiness at normal temperature and pressure before the step of arranging the fixing member and keeps a solid state having the elasticity and the stickiness at normal temperature and pressure also after the step of arranging the fixing member.

8. The manufacturing method of a plate-like member assembly according to claim 1, wherein the step of arranging the fixing member includes arranging the fixing member in the air on one surface opposite to the other surface which faces the first plate-like member.

9. The manufacturing method of a plate-like member assembly according to claim 1, wherein one of the first plate-like member and the second plate-like member is one of a touch panel and a display panel, and the other plate-like member is a transparent substrate protecting a surface of the one plate-like member opposed to the other plate-like member.

10. The manufacturing method of a plate-like member assembly according to claim 9, wherein the first plate-like member is the transparent substrate, and the projecting region is a printed region in which printing has been performed on the one surface of the transparent substrate.

11. The manufacturing method of a plate-like member assembly according to claim 10, wherein the printed region is shaped in a frame, and the light transmitting film is formed to cover a whole region inside of the printed region and a whole of an inner edge of the printed region.

12. The manufacturing method of a plate-like member assembly according to claim 1, wherein the step of forming the light transmitting film includes forming the light transmitting film by a method selected from the group consisting of coating one of a hard coating agent, coating a UV curable adhesive and printing a UV curable ink.

13. The manufacturing method of a plate-like member assembly according to claim 1, further comprising the step of autoclaving an assembly including the first plate-like member, the light transmitting film and the fixing member after the step of arranging the fixing member and before the step of arranging the second plate-like member.

14. The manufacturing method of a plate-like member assembly according to claim 1, further comprising the step of autoclaving an assembly including the first plate-like member, the light transmitting film, the fixing member and the second plate-like member after the step of arranging the second plate-like member.

15. A manufacturing method of a plate-like member assembly, comprising the steps of:
preparing a first plate-like member including a projecting region, projecting from one surface of the first plate-like member along a thickness direction thereof, on the one surface;
arranging a fixing member to cover a border between an overlapping region, overlapping the projecting region, and a nonoverlapping region, not-overlapping the projecting region, on the one surface of the first plate-like member;
pressurizing the fixing member at a region overlapping the border in one surface opposite to the other surface which faces the first plate-like member toward the first plate-like member while heating the fixing member; and
arranging a second plate-like member in such a way that the fixing member intervenes between the second plate-like member and the first plate-like member.

16. The manufacturing method of a plate-like member assembly according to claim 15, wherein
the fixing member is a solid having elasticity and stickiness at normal temperature and pressure before the step of arranging the fixing member, and
the step of heating the fixing member includes deforming the fixing member plastically.

17. The manufacturing method of a plate-like member assembly according to claim 15, wherein the step of arranging the fixing member includes arranging the fixing member on the one surface of the first plate-like member in a vacuum.

18. The manufacturing method of a plate-like member assembly according to claim 15, further comprising the step of autoclaving an assembly including the first plate-like member and the fixing member after the step of arranging the fixing member and before the step of arranging the second plate-like member.

19. The manufacturing method of a plate-like member assembly according to claim 15, further comprising the step of autoclaving an assembly including the first plate-like member, the fixing member, and the second plate-like member after the step of arranging the second plate-like member.

20. A manufacturing method of a plate-like member assembly, comprising the steps of:
preparing a first plate-like member including a first projecting region, projecting from one surface of the first plate-like member along a thickness direction thereof, on the one surface;
forming a light transmitting film, having a light transmitting property, in a nonoverlapping region, not-overlapping the first projecting region, on the one surface of the first plate-like member;
preparing a second plate-like member including a second projecting region, projecting from one surface of the second plate-like member along a thickness direction thereof, on the one surface;
arranging a fixing member to cover a border between an overlapping region, overlapping the second projecting region, and a nonoverlapping region, not-overlapping the second projecting region, on the one surface of the second plate-like member;
pressurizing the fixing member at a region overlapping the border in one surface opposite to the other surface which faces the second plate-like member toward the second plate-like member while heating the fixing member; and
arranging a first assembly including the first plate-like member and the light transmitting film and a second assembly of the second plate-like member and the fixing member in such a way that the light transmitting film and the fixing member overlap each other to fix the first assembly and the second assembly each other.

21. A manufacturing method of a plate-like member assembly, comprising the steps of:
preparing a first plate-like member including a first projecting region, projecting from one surface of the first plate-like member along a thickness direction thereof, on the one surface;
arranging a first fixing member to cover a first border between a first overlapping region, overlapping the first projecting region, and a first nonoverlapping region, not-overlapping the first projecting region, on the one surface of the first plate-like member;
pressurizing the first fixing member at a region overlapping the first border in one surface opposite to the other surface which faces the first plate-like member toward the first plate-like member while heating the first fixing member;
preparing a second plate-like member including a second projecting region, projecting from one surface of the second plate-like member along a thickness direction thereof, on the one surface;
arranging a second fixing member to cover a second border between a second overlapping region, overlapping the second projecting region, and a second nonoverlapping region, not-overlapping the second projecting region, on the one surface of the second plate-like member;
pressurizing the second fixing member at a region overlapping the second border in one surface opposite to the other surface which faces the second plate-like member toward the second plate-like member while heating the second fixing member; and
arranging a first assembly of the first plate-like member and the fixing member and a second assembly of the second plate-like member and the second fixing member in such a way that the fixing member and the second fixing member overlap each other to fix the first assembly and the second assembly each other.

22. A transparent substrate-including electronic member, comprising:
a transparent substrate including a printed region subjected to frame-shaped printing on one surface side thereof;
a light transmitting film, having a light transmitting property, the light transmitting film being formed to cover a whole region inside of the printed region and a whole of an inner edge of the printed region on the one surface of the transparent substrate;
a fixing member arranged to cover a border between a overlapping region, overlapping the printed region, and a nonoverlapping region, not-overlapping the printed region with the light transmitting film intervening between the fixing member and the transparent substrate; and
an electronic member which is one of a touch panel and a display panel, the electronic member being arranged in such a way that the light transmitting film and the fixing member intervene between the electronic member and the transparent substrate.
